(19) United States
(12) Patent Application Publication
(10) Pub. No.: US 2016/0268715 A1
(43) Pub. Date: Sep. 15, 2016

(54) Connector

(71) Applicant: Tyco Electronics Japan G.K., Kanagawa (JP)

(72) Inventor: Yoshihiko Kodaira, Kanagawa (JP)

(73) Assignee: Tyco Electronics Japan G.K., Kanagawa (JP)

(21) Appl. No.: 15/044,673

(22) Filed: Feb. 16, 2016

(30) Foreign Application Priority Data
Feb. 16, 2015 (JP) 2015-027763

(51) Int. Cl. H01R 12/71; H01R 24/60

(52) U.S. Cl. CPC H01R 12/716; H01R 24/60

(57) ABSTRACT

A connector is provided and includes a housing and a plurality of contacts. The housing includes a plurality of openings extending there through. The plurality of contacts are arranged along longitudinal sides of the housing and include a plurality of first contacts and a plurality of second contacts. The plurality of first contacts include a plurality of first soldering contact portions projecting from longitudinal sides to an outside of the housing. The plurality of second contacts are positioned to correspond with the plurality of openings and having a plurality of second soldering contact portions provided inside the longitudinal sides of the housing and are alternately arranged with respect to the plurality of first contacts.

### CROSS-REFERENCE TO RELATED APPLICATIONS

This application claims the benefit of the filing date under 35 U.S.C. §119 (a)-(d) of Japanese Patent Application No. 2015-027763, filed Feb. 16, 2015.

### FIELD OF THE INVENTION

The invention relates to a connector and, more particularly, to a surface mount connector.

### BACKGROUND

Surface mount connectors are frequently used, including for use with a flexible printed circuit board. These connectors are generally required to be reduced in size and reduced in height.

Recently, connectors further require multi-polarization even though the size reduction and the like are to be maintained. In order to realize such a requirement, space between contacts has been considered.

As shown in Japanese Patent Application JP 2000-516028 A, a connector exhibiting multi-polarization has been realized by arranging board contact portions of contacts not only outside a housing but also inside the same in a plan view is disclosed. As disclosed, arrangement portion of the board contact portions exist inside the housing. A large opening is provided to visibly solder the board contact portions of the contacts to a board with high reliability. However, the opening results in a structure unsuitable for size reduction. That is, if the disclosed connector is minimized, strength of the housing is compromised due to the large opening.

### SUMMARY

In view of these circumstances, an object of the present invention is to provide a connector adapting to multi-polarization while size reduction is being maintained. A connector is provided and includes a housing and a plurality of contacts. The housing includes a plurality of openings extending there through. The plurality of contacts are arranged along longitudinal sides of the housing and include a plurality of first contacts and a plurality of second contacts. The plurality of first contacts include a plurality of first soldering contact portions projecting from longitudinal sides to an outside of the housing. The plurality of second contacts are positioned to correspond with the plurality of openings and having a plurality of second soldering contact portions provided inside the longitudinal sides of the housing and are alternately arranged with respect to the plurality of first contacts.

### BRIEF DESCRIPTION OF THE DRAWINGS

The invention is explained in greater detail below with reference to embodiments and the appended drawings of which:

FIG. 1 is a perspective view of a connector according to the invention;

FIG. 2A is a top view of the connector of FIG. 1;

FIG. 2B is a bottom view of the connector of FIG. 1;

FIG. 3 is a perspective view of the connector of FIG. 1 connecting with a mating connector;

FIG. 4 is a top view of the connector of FIG. 3;

FIG. 5A is a cross-sectional view of the connector of FIG. 4 taken along line A-A;

FIG. 5B is a cross-sectional view of the connector of FIG. 4 taken along line B-B;

FIG. 6A is a schematic diagram of an arrangement of soldering connecting pads on a board that connects to a connector according to the invention; and

FIG. 6B is a schematic diagram of an arrangement of soldering connecting pads for a mating connector to which the connector according to the invention connects.

### DETAILED DESCRIPTION OF THE EMBODIMENT(S)

Embodiments of the present invention will be described with reference to the drawings.

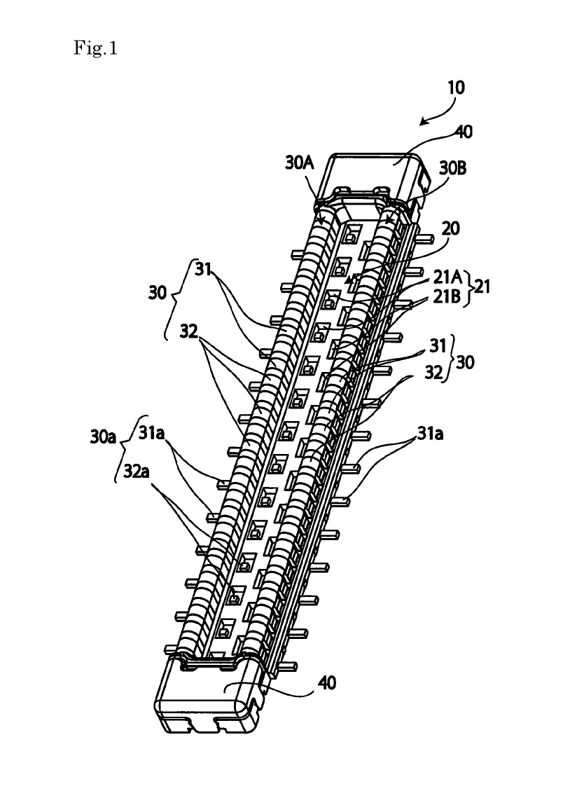

As shown in FIG. 1, a connector 10 according to the invention generally includes a housing 20, a plurality of contacts 30, and plurality of reinforcement metal fittings 40.

In the shown embodiment, the housing 20 is approximately rectangular shaped. The plurality of contacts 30 are arranged along longitudinal sides of the approximately rectangular shape. The contacts 30 are contacts arranged at an extremely short pitch such as, for example, a pitch of 0.25 mm. Further, the reinforcement metal fittings 40 are attached to both end portions of the housing 20 in a longitudinal direction thereof. The reinforcement metal fittings 40 are metal fittings for reinforcing mounting strength on a mounting board (not shown).

As shown, the plurality of contacts 30 include first contacts 31 and second contacts 32 alternately arranged with respect to each other. The first contact 31 and the second contact 32 have different soldering contact portions 30a from each other. That is, the first contact 31 has a first soldering contact portion 31a having a shape projecting from the above-described longitudinal side to outside of the housing 20. Alternatively, the second contact 32 includes a second soldering contact portion 32a provided inside the longitudinal side of the housing 20.

The first soldering contact portions 31a and second soldering contact portions 32a are configured to be soldered to on a board (for example, a flexible printed circuit) on which the connector 10 is mounted. Further, the reinforcement metal fittings 40 at the both end portions are also configured to be soldered and secured on the board.

The housing 20 includes small openings 21 to correspond to the second contacts 32, individually. These openings 21 allow inspection during soldering of the second soldering contact portions 32a when the connector 10 is mounted on a board. High reliability of soldering can be secured by inspecting the soldering from this opening 21.

Further, the openings 21 are small openings corresponding to the second contacts 32 individually and even if theses openings 21 are formed, the housing 20 is maintained so as to have a sufficient strength.

Further, the plurality of contacts 30 form a first contact row 30A and a second contact row 30B that arranged along two longitudinal sides of the housing 20, respectively. In both of the first contact row 30A and the second contact row 30B, the first contacts 31 and the second contact 32 are alternately arranged with respect to each other. However, the first contacts 31 providing the first contact row 30A and the second contacts 32 providing the second contact row 30B are arranged side by side regarding a width of the housing that intersects the longitudinal sides. Further, similarly thereto, the second contacts 32 providing the first contact row 30A and the first contacts 31 providing the second contact row 30B are arranged side by side as well.

Therefore, according to the disclosed arrangement, regarding the plurality of openings 21, first openings 21A corresponding to the first contact row 30A and second openings 21B corresponding to the second contact row 30B are also alternately arranged in a staggered manner. Here, the first openings 21A are openings for allowing visual inspection of soldering of the second soldering contact portions 32a of the second contacts 32 that provide the first contact row 30A. Further, the second openings 21B are openings allowing visual inspection of the soldering of the second soldering contact portions 32a providing the second contact row 30B. As described above, in both the first contact row 30A and the second contact row 30B, the first contacts 31 and the second contacts 32 are alternately arranged. Therefore, in both of the first openings 21A and the second openings 21B, an arrangement pitch in the direction of the longitudinal side is expanded to twice as much as a space between the contacts 30. Further, arrangements of the second contacts 32 in the first contact row 30A and in the second contact row 30B are shifted from each other by one pitch. Therefore, the second soldering contact portions 32a and the openings 21 are arranged in the staggered manner between the first contact row 30A and the second contact row 30B. Thereby, a space between the second soldering contact portions 32a and a space between the openings 21 are extended, so that excellent electrical characteristic is secured and the strength of the housing 20 is secured.

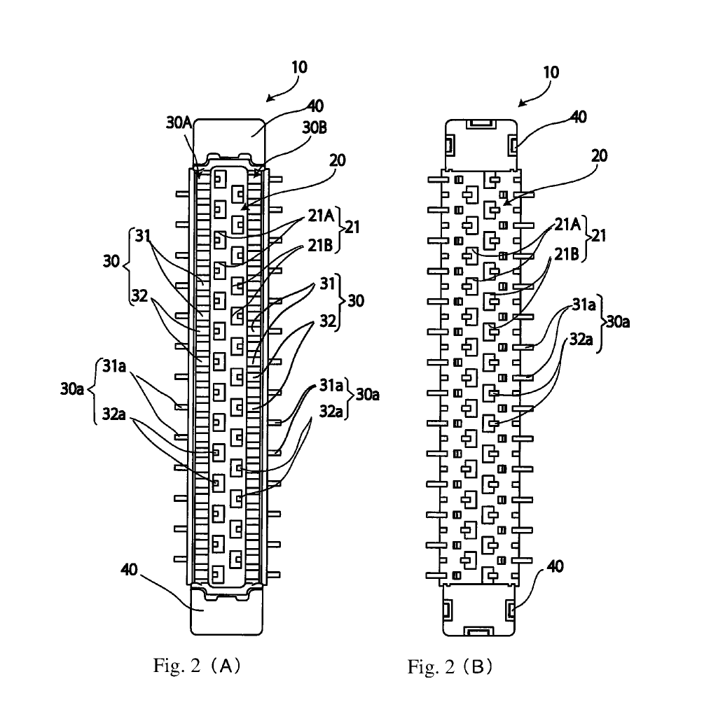

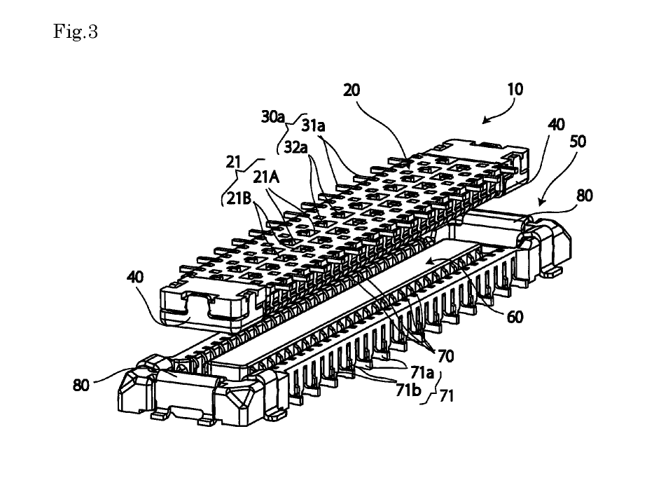

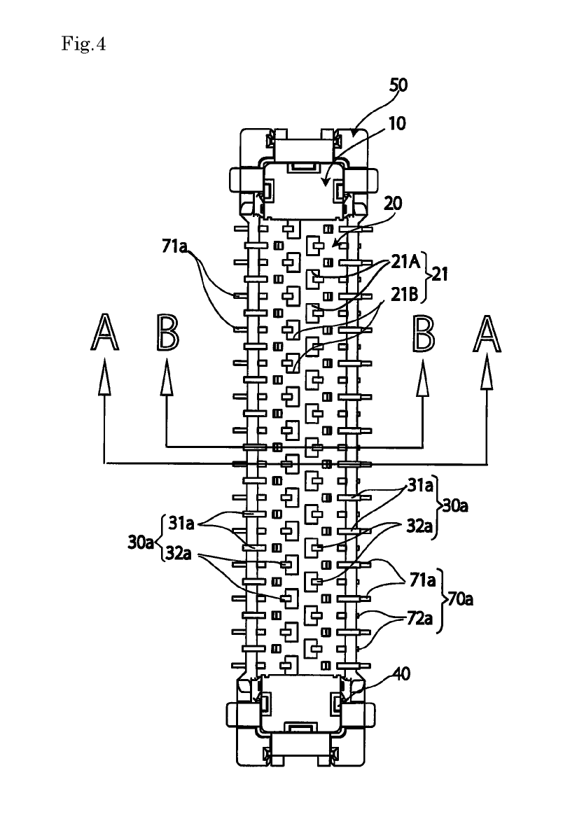

As shown in FIG. 3, the connector 10 is mated with the mating connector 50 such that an upper face shown in FIG. 1 and FIG. 2A is directed to the mating connector 50.

The mating connector 50 includes a housing 60, a plurality of contacts 70, and reinforcement fitting metals 80. The contacts 70 of the mating connector 50 are also arranged in two rows corresponding to that the contacts 30 of the connector 10 are arranged in the two rows.

The mating connector 50 is surface-mounted on a mounting board (not shown; for example, a rigid board).

Further, the contacts 70 include two kinds of the contacts 70, due to a difference in a soldering contact portion 71. That is, the contacts 70 some contacts that include a first soldering contact portion 71a and other contacts that include a second soldering contact portion 71b. The first soldering contact portions 71a project largely from a longitudinal side of the housing 60. Alternatively, the second soldering contact portions 71b are positioned at positions slightly projecting from the longitudinal side of the housing 60. The contacts 70 having the first soldering contact portion 71a and the contacts 70 having the second soldering contact portion 71b are alternately arranged along the longitudinal sides with respect to each other. However, in the case of the mating connector 50, two contacts having the first soldering contact portion 71a are arranged in a widthwise direction intersecting the longitudinal sides of the housing 60, which is different from the connector 10. Further, similarly thereto, in the mating connector 50, two contacts 70 having the second soldering contact portion 71b are arranged in the widthwise direction.

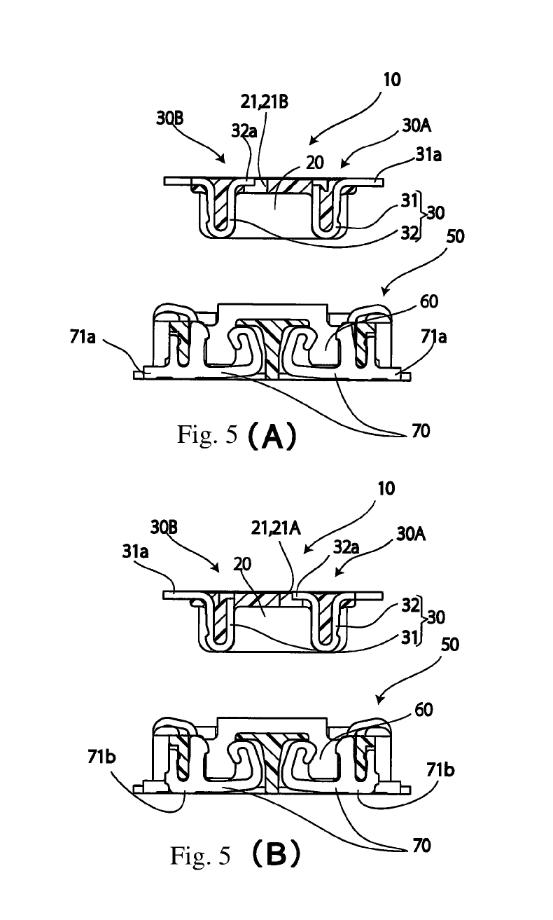

As shown in FIG. 5A, the connector 10 includes the first contacts 31 arranged in the first contact row 30A and the second contacts 32 arranged in the second contact row 30B. The first contacts 31 arranged in the first contact row 30A have the first soldering contact portions 31a projecting from the housing 20. Further, the second contacts 32 arranged in the second contact row 30B have the second soldering contact portions 32a arranged at positions visually inspected through the openings 21 (the second openings 21B) of the housing 20. On one hand, in this FIG. 5A, regarding the mating connector 50, two contacts 70 having the first soldering contact portion 71a projecting largely from the housing 60 are shown.

As shown in FIG. 5B, the connector 10 includes the second contact 32 arranged in the first contact row 30A and the first contact 31 arranged in the second contact row 30B. The second contact 32 arranged in the first contact row 30A include the second soldering contact portion 32a arranged at a position where the second soldering contact portion 32a can be visually inspected from the opening 21 (the first opening 21A) of the housing 20. The first contact 31 arranged in the second contact row 30B has the first soldering contact portion 31a projecting from the housing 20. As shown, the mating connector 50 includes two contacts 70 having the second soldering contact portion 71b arranged at a position where the second soldering contact portion 71b can be slightly viewed.

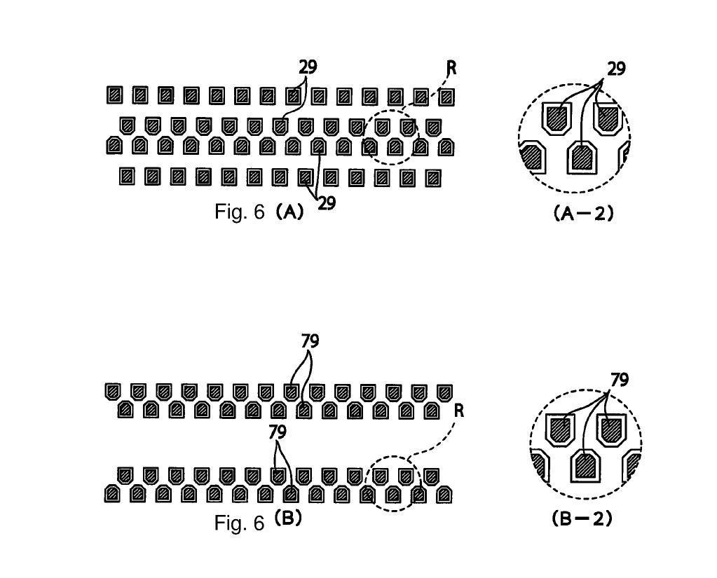

As shown in FIG. 6A, an arrangement of pads to which the contacts 30 of the connector 10 are soldered and connected is shown. Further, in FIG. 6B, an arrangement of pads to which the contacts 70 of the mating connector 50 are soldered and connected is shown. As shown, pads 29, 79 are arranged in a staggered manner. Regarding the pads 29, 79 close to each other, they are formed in a shape where their corners have been cut. Further, the soldering contact portions 30a, 70a of the contacts 30, 70 contacting with the pads 29, 79 are formed to have a similar shape to the pads 29, 79, as shown by hatching in FIG. 6.

Thereby, a space between the pads 29 and a space between the pads 79 are secured, and occurrence of bridging at a soldering time is prevented.

Incidentally, the example where the plurality of contacts 30 have been arranged in two rows of the first contact row 30A and the second contact row 30B has been here described. However, the invention can be applied to even a connector where a plurality of contacts are arranged in one row.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing having a plurality of openings extending there through; and
a plurality of contacts arranged along longitudinal sides of the housing and having:
a plurality of first contacts with a plurality of first soldering contact portions projecting from the longitudinal sides to an outside of the housing; and
a plurality of second contacts positioned to correspond with the plurality of openings and having a plurality of second soldering contact portions provided inside the longitudinal sides of the housing and being alternately arranged with respect to the plurality of first contacts.

2. The connector according to claim 1, wherein the housing is rectangular shaped.

3. The connector according to claim 1, further comprising a first contact row positioned along one longitudinal side and a second positioned along an opposite longitudinal side.

4. The connector according to claim 3, wherein the plurality of first contacts in the first contact row and the plurality of second contacts in the second contact row are arranged side by side with respect to a width of the housing that intersects the longitudinal sides.

5. The connector according to claim 4, wherein the plurality of second contacts in the first contact row and the plurality of first contacts in the second contact row are arranged side by side with respect to the width of the housing.

6. The connector according to claim 5, wherein the plurality of openings include a plurality of first openings corresponding to the plurality of second soldering contact portions of the first contact row.

7. The connector according to claim 6, wherein the plurality of openings further includes a plurality of second openings corresponding to the plurality of second soldering contact portions of the second contact row.

8. The connector according to claim 7, wherein the plurality of first openings and the plurality of second openings are alternately positioned in a staggered arrangement.
